(19) United States
(12) Patent Application Publication
(10) Pub. No.: US 2023/0062547 A1
(43) Pub. Date: Mar. 2, 2023

(54) PROJECTION DEVICE

(71) Applicant: IVIEW DISPLAYS (SHENZHEN) COMPANY LTD., Shenzhen (CN)

(72) Inventors: Mingnei Ding, Shenzhen (CN); Steve Yeung, Hong Kong (CN); Zhiqiang Gao, Hong Kong (CN); Xiang Li, Shenzhen (CN)

(21) Appl. No.: 17/700,618

(22) Filed: Mar. 22, 2022

Related U.S. Application Data
(63) Continuation of application No. PCT/CN2021/114584, filed on Aug. 25, 2021.

(51) Int. Cl. G03B 21/14; G03B 21/28

(52) U.S. Cl. CPC G03B 21/142; G03B 21/28

(57) ABSTRACT

Embodiments of the present disclosure relate to the technical field of projection and display, and in particular, relate to a projection device. The projection device includes: a base, provided with a receiving chamber and a first opening, wherein the first opening is in communication with the receiving chamber; a projection unit, mounted in the receiving chamber, wherein a projection screen output by the projection unit is emitted out from the first opening; a light-transmissive strut, wherein one end of the light-transmissive strut is mounted on the base; a mounting plate, fixed to the other end of the light-transmissive strut; a first drive device, mounted on the mounting plate; a reflective mirror, mounted on the first drive device, wherein the reflective mirror is disposed opposite to the projection unit, the reflective mirror is configured to reflect the projection screen output by the projection unit, and the first drive device is configured to drive the reflective mirror to rotate to adjust an output direction of the projection screen. Accordingly, the projection screen reflected by the reflective mirror in the embodiments of the present disclosure may directly pass through the light-transmissive strut, thereby increasing the projection region of the projection screen.

### CROSS-REFERENCE TO RELATED APPLICATION

This application is based upon and claims priority to Chinese Patent Application No. 202110820873.7, filed before China National Intellectual Property Administration on Jul. 20, 2021 and entitled “PROJECTION DEVICE,” the entire contents of which are incorporated herein by reference.

### TECHNICAL FIELD

Embodiments of the present disclosure relate to the technical field of projection and display, and in particular, relate to a projection device.

### BACKGROUND

A projection device is an optical instrument which magnifies, by using optical elements, a screen to be projected, such as an image, a video, or a 3D animation, and projects the magnified screen to be projected onto a curtain or a wall. Some projection devices may be connected to a computer, a VCD, a DVD, a BD, a game machine, a DV, and the like via different interfaces to play corresponding video signals. With the rapid development of digital light processing projection technologies, projection systems are promoted to develop rapidly, and people impose higher requirements for projection systems. At present, motion-based projection applicable to various application scenarios, such as families, large-scale stages, has received wide attention. A motion-based projection device needs to multi-directionally project images according to a user instruction, and needs to be synchronized with projection content, such that an immersive experience is created for a user by combining motion with content.

During practice of the present disclosure, the inventors have found that: In the current motion-based projection scheme, and when a reflective mirror is adjusted to rotate to a certain angle, a projection screen is blocked by a supporting device of the projection device, such that adjustment range of a projection direction becomes smaller, and thus unique immersive experience of motion-based projection is reduced.

### SUMMARY

With respect to the above defects in the related art, embodiments of the present disclosure are intended to provide a projection device, which is capable of increasing a projection region.

To overcome the above technical problem, one technical solution provided by the embodiments of the present disclosure is a projection device. The projection device includes: a base, provided with a receiving chamber and a first opening, wherein the first opening is in communication with the receiving chamber; a projection unit, mounted in the receiving chamber, wherein a projection screen output by the projection unit is emitted out from the first opening; a light-transmissive strut, wherein one end of the light-transmissive strut is mounted on the base; a mounting plate, fixed to the other end of the light-transmissive strut; a first drive device, mounted on the mounting plate; a reflective mirror, mounted on the first drive device, wherein the reflective mirror is disposed opposite to the projection unit, the reflective mirror is configured to reflect the projection screen output by the projection unit, and the first drive device is configured to drive the reflective mirror to rotate to adjust an output direction of the projection screen.

In an optional embodiment, the projection device further includes: a power supply module, a power feeder coil, a power receiver coil, and a rectifier circuit; wherein the power supply module and the power feeder coil are disposed on the base, the power supply module is connected to both the projection unit and the power feeder coil, and the power supply module is configured to supply power to the projection unit and the power feeder coil; and the power receiver coil and the rectifier circuit are disposed on the mounting plate, the power receiver coil is disposed in a magnetic field of the power feeder coil, the power receiver coil is connected to the rectifier circuit, the rectifier circuit is connected to the first drive device, and the rectifier circuit is configured to supply power to the first drive device.

In an optional embodiment, the projection device further includes: a controller, a first wireless communication module, and a second wireless communication module; wherein the controller and the first wireless communication module are disposed on the base, the controller is connected to both the projection unit and the first wireless communication module, the second wireless communication module is disposed on the mounting plate, the second wireless communication module is connected to the first drive device, the first wireless communication module is communicably connected to the second wireless communication module, and the controller sends a control signal to the first drive device via the first wireless communication module and the second wireless communication module.

In an optional embodiment, the projection device further includes: a second drive device; wherein the second drive device is mounted on the base, the second drive device is connected to one end of the light-transmissive strut, and the second drive device is configured to drive the light-transmissive strut to rotate.

In an optional embodiment, the base is provided with a second opening; and the second drive device includes a bearing and a first motor, wherein the bearing is fixed to the second opening, the bearing is sleeved onto one end of the light-transmissive strut, the first motor is fixed to the receiving chamber, the first motor is fixed to one end of the light-transmissive strut, and the first motor is configured to drive the light-transmissive strut to rotate.

In an optional embodiment, the projection device further includes: a light-transmissive cover plate; wherein the light-transmissive cover plate covers the first opening.

In an optional embodiment, the first drive device includes: a first rotation assembly, fixed to the other end of the light-transmissive strut; and a second rotation assembly, fixed to the first rotation assembly, wherein the reflective mirror is fixed to the second rotation assembly, the first rotation assembly is configured to drive the second rotation assembly to rotate in a first direction, and the second rotation assembly is configured to drive the reflective mirror to rotate in a second direction, the first direction being different from the second direction.

In an optional embodiment, the first rotation assembly includes: a driven gear, a driving gear, and a second motor; wherein the driven gear is fixed to the second rotation assembly, the second motor is fixed to the mounting plate, a rotation shaft of the second motor is fixed to the driving gear, and the driving gear is in mesh with the driven gear.

In an optional embodiment, the second rotation assembly includes: a third motor and a support arm; wherein the support arm is rotatably connected to the mounting plate, the driven gear is fixed to the support arm, a housing of the third motor is fixed to the reflective mirror, and a rotation shaft of the third motor is fixed to the support arm.

In an optional embodiment, the projection device further includes: a first position sensor, fixed to the second motor; and a second position sensor, fixed to the support arm.

Compared with the related art, the embodiments of the present disclosure may achieve the following beneficial effects: A projection screen output by the projection unit is emitted out from the first opening, the reflective mirror is disposed opposite to the projection unit, the reflective mirror is configured to reflect the projection screen output by the projection unit, and the first drive device is fixed to the reflective mirror and configured to drive the reflective mirror to rotate to adjust an output direction of the projection screen. Accordingly, the projection screen reflected by the reflective mirror in the embodiment of the present disclosure may directly pass through the light-transmissive strut, thereby increasing the projection region of the projection screen.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic structural view of a projection device according to an embodiment of the present disclosure;

FIG. 2 is a top view of the projection device according to an embodiment of the present disclosure;

FIG. 3 is a schematic diagram of establishing a communication connection between a base and a mounting plate in the projection device as illustrated in FIG. 1;

FIG. 4 is a schematic diagram of connections of a mounting plate in the projection device as illustrated in FIG. 1; and

FIG. 5 is an exploded view of a first drive device and a reflective mirror in the projection device as illustrated in FIG. 1.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

Hereinafter, the embodiments of the present disclosure are further illustrated with reference to the accompanying drawings.

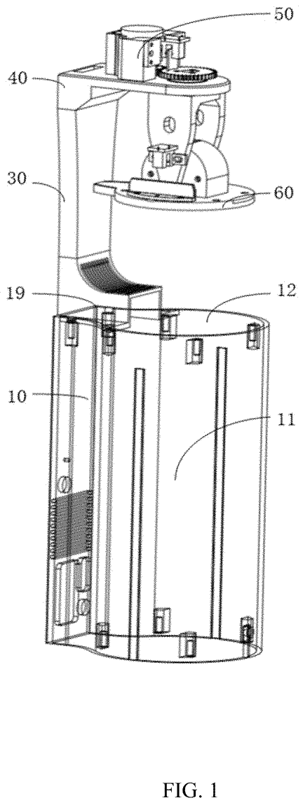

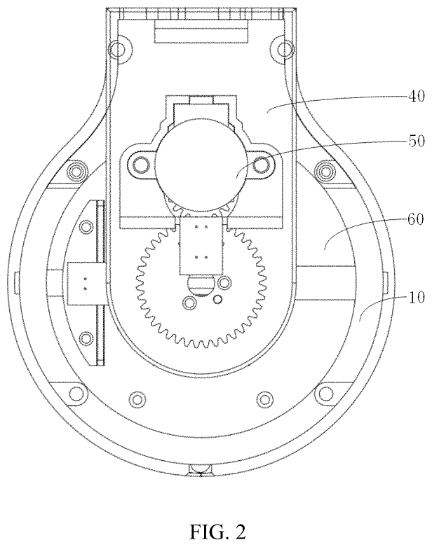

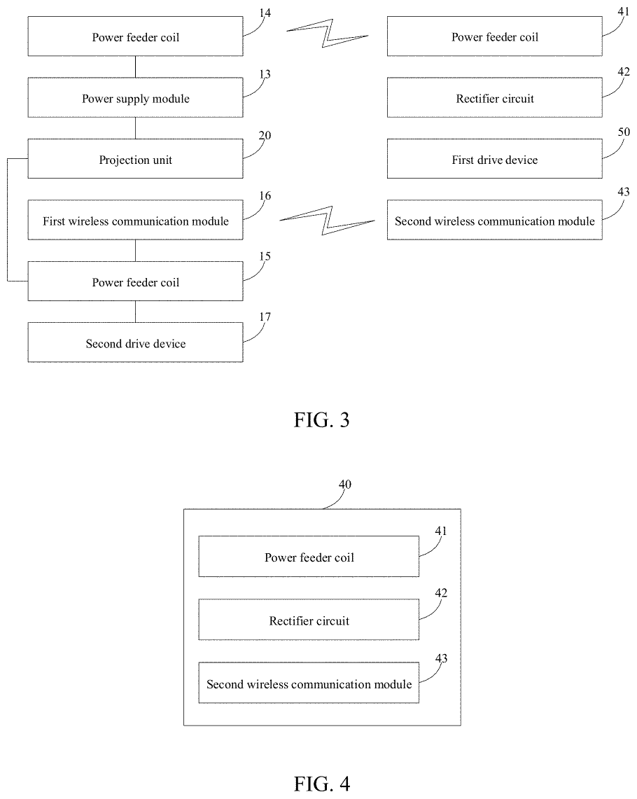

As illustrated in FIG. 1 and FIG. 2, a projection device according to an embodiment of the present disclosure includes: a base 10, a projection unit 20 (as illustrated in FIG. 3), a light-transmissive strut 30, a mounting plate 40, a first drive device 50, and a reflective mirror 60. The projection unit 20 is received in the base 10, one end of the base 10 is fixed to the light-transmissive strut 30, the other end of the light-transmissive strut 30 is fixed to the mounting plate 40, the first drive device 50 is mounted on the mounting plate 40, and the other end of the first drive device 50 is fixed to the reflective mirror 60. The reflective mirror 60 is disposed opposite to the projection unit 20, the reflective mirror 60 is configured to reflect a projection screen output by the projection unit 20, and the first drive device 50 is configured to drive the reflective mirror 60 to rotate to adjust an output direction of the projection screen.

With respect to the base 10, referring to FIG. 2 and FIG. 3, the base 10 is provided with a receiving chamber 11 and a first opening 12, wherein the first opening 12 is in communication with the receiving chamber 11; the projection unit 20 is received in the receiving chamber 11; and the projection screen output by the projection unit 20 is emitted out from the first opening 12. The receiving chamber 11 further accommodates a power supply module 13, a power feeder coil 14, a controller 15, and a first wireless communication module 16. The power supply module 13 is connected to the projection unit 20, the power feeder coil 14, the controller 15, and the first wireless communication module 16. The power supply module 13 is configured to supply power to the projection unit 20, the power feeder coil 14, the controller 15, and the first wireless communication module 16. The controller 15 is connected to both the projection unit 20 and the first wireless communication module 16 and configured to control and adjust the first wireless communication module 16, and the first wireless communication module 16 is configured to implement wireless communication.

It is understandable that, in some embodiments, the base 10 further includes a second drive device 17; wherein the second drive device 17 is mounted on the base 10, the second drive device 17 is connected to both the controller 15 and one end of the light-transmissive strut 30, and the second drive device 17 is configured to drive the light-transmissive strut 30 to rotate. In this case, the base 10 is provided with a second opening 18, and the second drive device 17 includes a bearing (not illustrated) and a first motor (not illustrated), wherein the bearing is fixed to the second opening 18, the bearing is sleeved onto one end of the light-transmissive strut 30, the first motor is fixed to the receiving chamber 11, the first motor is fixed to one end of the light-transmissive strut 30, and the first motor is configured to drive the light-transmissive strut 30 to rotate. In the case that the controller 15 controls the first motor to start, and then the first motor drives the light-transmissive strut 30 to rotate, the light-transmissive strut 30 drives the mounting plate 40, the first drive device 50, and the reflective mirror 60 to rotate together, such that the rotation of the projection screen within a 360-degree range in a horizontal direction is achieved.

It is understandable that, in some embodiments, the base 10 is made of an aluminum alloy material to facilitate heat dissipation, the first opening 12 is covered with a light-transmissive cover plate (not illustrated), and the light-transmissive cover plate protects the components in the base 10 from damage while ensuring that the projection unit 20 is capable of projecting the projection screen to the reflective mirror 60.

With respect to the light-transmissive strut 30, the light-transmissive strut 30 is made of a light-transmissive material to ensure that the projection screen reflected by the reflective mirror 60 is not blocked by the strut.

With respect to the mounting plate 40, as illustrated in FIG. 4, the mounting plate 40 is provided with a power receiver coil 41, a rectifier circuit 42, and a second wireless communication module 43. The power receiver coil 41 is disposed in a magnetic field of the power feeder coil 14, and the power receiver coil 41 is connected to the rectifier circuit 42, such that the rectifier circuit 42 generates direct current. The rectifier circuit 42 is connected to the first drive device 50, and the rectifier circuit 42 is configured to supply power to the first drive device 50. The second wireless communication module 43 is disposed on the mounting plate 40, and the second wireless communication module 43 is connected to both the rectifier circuit 42 and the first drive device 50. In the case that the rectifier circuit 42 supplies power to the second wireless communication module 43, the second wireless communication module 43 is in wireless communication connection to the first wireless communication module 16.

It should be noted that the first wireless communication module 16 is communicably connected to the second wireless communication module 43, and the controller 15 sends a control signal to the first drive device 50 via the first wireless communication module 16 and the second wireless communication module 43, such that the first drive device 50 is wirelessly controlled, and thus a direction of the projection screen reflected by the reflective mirror 60 is adjusted.

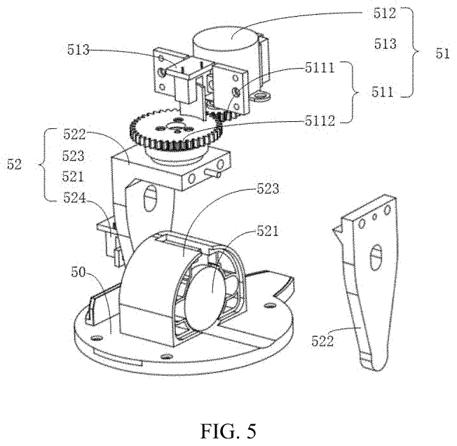

With respect to the first drive device 50, referring to FIG. 5, the first drive device 50 includes: a first rotation assembly 51, fixed to the other end of the light-transmissive strut 30; and a second rotation assembly 52, fixed to the first rotation assembly 51, wherein the reflective mirror 60 is fixed to the second rotation assembly 52, the first rotation assembly 51 is configured to drive the second rotation assembly 52 to rotate in a first direction, and the second rotation assembly 52 is configured to drive the reflective mirror 60 to rotate in a second direction. The first direction is different from the second direction.

In an embodiment of the present disclosure, the first direction is a yaw angle, and the second direction is a pitch angle. In some other embodiments, the first direction and the second direction may be two directions perpendicular to each other, or two directions that are not perpendicular to each other but different from each other, and may be set according to actual needs, which is not limited to the description in the embodiments of the present disclosure.

With respect to the first rotation assembly 51, the first rotation assembly 51 includes a driven gear 5111, a driving gear 5112, and a second motor 512; the second motor 512 is fixed to the mounting plate, and a rotation shaft of the second motor 512 is fixed to the driving gear 5112; the driving gear 5112 is in mesh with the driven gear 5111; and the second rotation assembly 52 is fixed to the driven gear 5111. The driven gear 5111 and the driving gear 5112 form a gear reduction box 511. The second motor 512 drives the gear reduction box 511, such that the second rotation assembly 52 fixed to the driven gear 5111 rotates about a central axis of the driven gear 5111.

With respect to the second rotation assembly 52, the second rotation assembly 52 includes a third motor 521 and a support arm 522. The support arm 522 is connected to the first rotation assembly 51, and is rotatable relative to the mounting plate, the support arm 522 is fixed to the driven gear 5111, and a rotation shaft of the third motor 521 is fixed to the support arm 522.

In some embodiments, the second motor 512 and the third motor 521 are also each provided with a motor winder to prevent the wire twisting in the case that an adjustment unit rotates.

In some embodiments, the second rotation assembly 52 includes a motor fixing frame 523; wherein the reflective mirror 60 is fixed to the motor fixing frame 523, the third motor 521 is fixed inside the motor fixing frame 523, the rotation shaft of the third motor 521 is extended out of the motor fixing frame 523, and the motor fixing frame 523 is rotatably connected to the other end of the support arm 522.

In an embodiment of the present disclosure, the third motor 521 rotates to drive the reflective mirror 60 fixed to the motor fixing frame 523 to rotate in the second direction.

In some embodiments, the projection device 1 further includes: a first position sensor 513, a second position sensor 524, and the controller 15, wherein the first position sensor 513 is fixed to the second motor 512, and the second position sensor 524 is fixed to the support arm 522.

The first position sensor 513 and the second position sensor 524 are angular displacement sensors, and further, may be capacitive sensors with high sensitivity to measure variations of angular displacement amounts of the first rotation assembly 51 and the second rotation assembly 52, which are sensing devices capable of converting the measured angular displacements caused by rotations of shaft into an electric signal based on capacitance variations.

In an embodiment of the present disclosure, the projection screen output by the projection unit 20 is emitted out from the first opening 12; the reflective mirror 60 is disposed opposite to the projection unit 20, the reflective mirror 60 is configured to reflect the projection screen output by the projection unit 20; the first drive device 50 is fixed to the reflective mirror 60, and configured to drive the reflective mirror 60 to rotate to adjust an output direction of the projection screen; and the projection screen reflected by the reflective mirror 60 may directly pass through the light-transmissive strut. With the above configurations, the projection region of the projection screen is increased in the embodiments of the present disclosure.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

What is claimed is:

1. A projection device, comprising:
a base, provided with a receiving chamber and a first opening, wherein the first opening is in communication with the receiving chamber;
a projection unit, mounted in the receiving chamber, wherein a projection screen output by the projection unit is emitted out from the first opening;
a light-transmissive strut, wherein one end of the light-transmissive strut is mounted on the base;
a mounting plate, fixed to the other end of the light-transmissive strut;
a first drive device, mounted on the mounting plate;
a reflective mirror, mounted on the first drive device, wherein the reflective mirror is disposed opposite to the projection unit, the reflective mirror is configured to reflect the projection screen output by the projection unit, and the first drive device is configured to drive the reflective mirror to rotate to adjust an output direction of the projection screen.

2. The projection device according to claim 1, further comprising: a power supply module, a power feeder coil, a power receiver coil, and a rectifier circuit; wherein
the power supply module and the power feeder coil are disposed on the base, the power supply module is connected to both the projection unit and the power feeder coil, and the power supply module is configured to supply power to the projection unit and the power feeder coil; and
the power receiver coil and the rectifier circuit are disposed on the mounting plate, the power receiver coil is disposed in a magnetic field of the power feeder coil, the power receiver coil is connected to the rectifier circuit, the rectifier circuit is connected to the first drive device, and the rectifier circuit is configured to supply power to the first drive device.

3. The projection device according to claim 1, further comprising: a controller, a first wireless communication module, and a second wireless communication module;
wherein the controller and the first wireless communication module are disposed on the base, the controller is connected to both the projection unit and the first wireless communication module, the second wireless communication module is disposed on the mounting plate, the second wireless communication module is connected to the first drive device, the first wireless communication module is communicably connected to the second wireless communication module, and the controller sends a control signal to the first drive device via the first wireless communication module and the second wireless communication module.

4. The projection device according to claim 1, further comprising: a second drive device; wherein the second drive device is mounted on the base, the second drive device is connected to one end of the light-transmissive strut, and the second drive device is configured to drive the light-transmissive strut to rotate.

5. The projection device according to claim 4, wherein
the base is provided with a second opening; and
the second drive device comprises a bearing and a first motor, wherein the bearing is fixed to the second opening, the bearing is sleeved onto one end of the light-transmissive strut, the first motor is fixed to the receiving chamber, the first motor is fixed to one end of the light-transmissive strut, and the first motor is configured to drive the light-transmissive strut to rotate.

6. The projection device according to claim 1, further comprising: a light-transmissive cover plate; wherein the light-transmissive cover plate covers the first opening.

7. The projection device according to claim 1, wherein the first drive device comprises:
a first rotation assembly, fixed to the other end of the light-transmissive strut; and
a second rotation assembly, fixed to the first rotation assembly, wherein the reflective mirror is fixed to the second rotation assembly, the first rotation assembly is configured to drive the second rotation assembly to rotate in a first direction, and the second rotation assembly is configured to drive the reflective mirror to rotate in a second direction, the first direction being different from the second direction.

8. The projection device according to claim 7, wherein the first rotation assembly comprises: a driven gear, a driving gear, and a second motor;
wherein the driven gear is fixed to the second rotation assembly, the second motor is fixed to the mounting plate, a rotation shaft of the second motor is fixed to the driving gear, and the driving gear is in mesh with the driven gear.

9. The projection device according to claim 8, wherein the second rotation assembly comprises: a third motor and a support arm;
wherein the support arm is rotatably connected to the mounting plate, the driven gear is fixed to the support arm, a housing of the third motor is fixed to the reflective mirror, and a rotation shaft of the third motor is fixed to the support arm.

10. The projection device according to claim 9, further comprising:
a first position sensor, fixed to the second motor; and
a second position sensor, fixed to the support arm.
